(19) United States
(12) Patent Application Publication
(10) Pub. No.: US 2026/0095238 A1
(43) Pub. Date: Apr. 2, 2026

(54) Autonomous Repeater System

(71) Applicant: The United States of America, as represented by the Secretary of the Navy, San Diego, CA (US)

(72) Inventors: Ryan A. Bell, Charleston, SC (US); Brett A. Bendt, Charleston, SC (US)

(21) Appl. No.: 18/899,189

(22) Filed: Sep. 27, 2024

(51) Int. Cl. H04B 7/155; H04B 17/336

(52) U.S. Cl. CPC H04B 7/15507; H04B 17/336

(57) ABSTRACT

An autonomous repeater system includes a processor node, a storage device, and two or more nodes. The processor node includes a processor, software, and a processor communication device. The software autonomously and continuously queries latitude data, longitude data, and signal-to-noise ratio data from two or more nodes and calculates a target latitude and a target longitude for each node using the latitude data, the longitude data, and the signal-to-noise ratio data received from the two or more nodes. The processor communication device is operatively connected to the processor to transmit or receive the latitude data, longitude data, and signal-to-noise ratio data between the two or more nodes and the processor and transmitting the target latitude and the target longitude calculated for each node. Each node includes a node communication device that transmits and receives data between the two or more nodes and the computer processor.

### STATEMENT REGARDING FEDERALLY SPONSORED RESEARCH OR DEVELOPMENT

The invention described herein may be manufactured and used by or for the government of the United States of America for governmental purposes without the payment of any royalties thereon or therefor. Licensing and technical inquiries may be directed to the Office of Research and Technical Applications, Space and Naval Warfare Systems Center, Atlantic, Code 70F00, North Charleston, SC, 29419-9022; 843-637-5890; niwc_lant-t2.fct@us.navy.mil; reference Navy Case Number 210829.

### BACKGROUND

Radio frequency (RF) repeaters are transmitters and receivers that receive a signal and retransmit that signal to another receiver or transceiver. This allows a radio to transmit a signal a longer distance than the radio alone would typically be unable to transmit. For example, two radios that are out of line-of-sight due to blockage (e.g., a mountain, buildings, etc.) for a RF signal to be transmitted can use a RF repeater to allow the signal to transmit by circumventing or overcoming the propagation loss of the blockage. Other signal repeaters are also used in different applications, such as optical repeaters that amplify light beams in an optical fiber cable.

### DESCRIPTION OF THE DRAWINGS

Features and advantages of examples of the present disclosure will be apparent by reference to the following detailed description and drawings, in which like reference numerals correspond to similar, but in some instances, not identical, components. Reference numerals or features having a previously described function may or may not be described in connection with other drawings in which they appear.

FIG. 1 is an example of the autonomous repeater system described herein that is a sequentially chained networked coverage scenario to transmit and receive data to each node;

FIG. 2 is an example of coverage plots for each node and the overlapping regions that are used to determine the target latitude and target longitude for each node;

FIG. 3 is another example of coverage plots for each node and the overlapping regions that are used to determine the target latitude and target longitude for each node;

FIG. 4 is an example of coverage plots with future trajectories with each node and coverage plots for each node with future overlapping regions used to determine future target latitudes and future target longitudes for each node;

FIG. 5A-5C are examples of plots showing the target latitude and target longitude calculations using the signal-to-noise ratio of RF transmission and reception signals between two nodes;

FIG. 6 is an example of the processor node described herein;

FIG. 7 is an example of the processor node described herein using an onboard networking of a platform as a bus;

FIG. 8 an example of the processor node described herein using multiple radios for a single node, whereby each radio maintains the ability to connect to the same or different networks;

FIG. 9 is an example of the autonomous repeater system described herein using a mesh networked coverage scenario to transmit and receive data to each node; and

FIG. 10 is an example of a method of using an autonomous repeater system.

### DETAILED DESCRIPTION

Repeaters are typically employed in dynamic environments that require adjustments to maintain reception and transmission of incoming signals. For example, some repeaters are deployed in water (e.g., ocean, lake, etc.) attached to a floating buoy. The repeaters in dynamic environments are susceptible to environmental changes that may cause a reduction or loss of the incoming signal reception. In the example of the floating buoy, surface and tidal currents may cause the buoy to move. In this scenario, the environmental changes can be mitigated by using a buoy. However, the repeater is now static and cannot adjust positions without manual intervention. In other examples, a repeater may need to be continuously repositioned. Currently, in these situations, a repeater is manually moved to a different location to improve signal strength between the repeater, the incoming signal, the device the signal is being transmitted to by the repeater, or both.

A system is described herein that allows the autonomous repositioning of a repeater to improve the repeater performance in a dynamic environment. A handheld device, a manned platform, or an unmanned platform (e.g., an unmanned underwater vehicle, unmanned aerial vehicle, unmanned surface vehicle, etc.) acts as an autonomous repeater. A processor continuously queries and stores GPS data to calculate the optimal position for the platform or multiple platforms to relocate to obtain the optimal signal strength between the incoming signal and relaying that signal to the processor. This allows the autonomous repeater system to be deployed in dynamic environments without the need for manual intervention to improve or maintain optimal signal strength between the repeater, the incoming signal, the device the signal is being transmitted to by the repeater, or both.

An autonomous repeater system is described herein that includes a processor node, a storage device, and two or more nodes. The processor node includes a processor, software, and a processor communication device. The processor is operatively connected to a storage device and a processor communication device and includes software that operates on the processor. The software autonomously and continuously queries latitude data, longitude data, and signal-to-noise ratio data from two or more nodes and calculates a target latitude and a target longitude for each node using the latitude data, the longitude data, and the signal-to-noise ratio data received from the two or more nodes. The processor communication device is operatively connected to the processor to transmit and receive the latitude data, longitude data, and signal-to-noise ratio data between the two or more nodes and the processor and transmit the target latitude and the target longitude calculated for each node. The storage device timestamps and stores the latitude data, the longitude data, and the signal-to-noise ratio data being queried by the software. Each node includes a node communication device that transmits and receives the latitude data, the longitude data, and the signal-to-noise ratio data between the two or more nodes and the processor and receives the target latitude and the target longitude from the processor communication device.

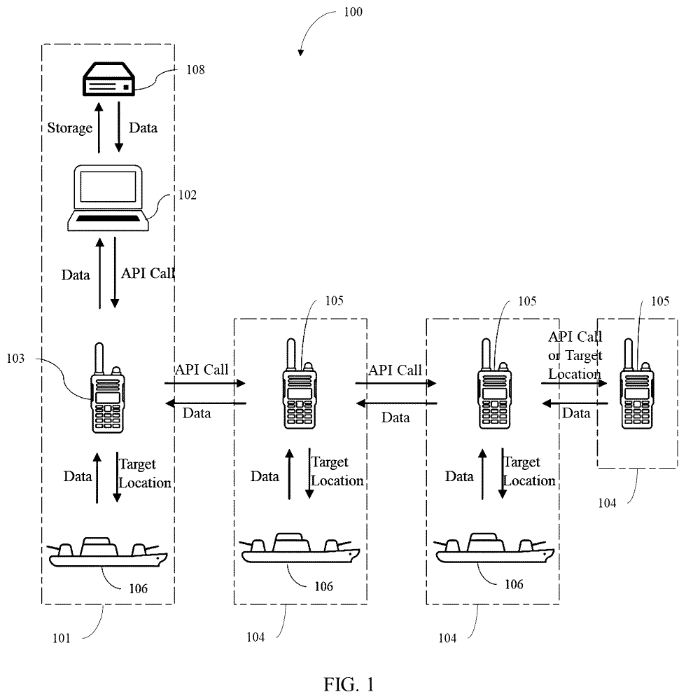

Referring now to FIG. 1, an example of the autonomous repeater system 100 is shown. The autonomous repeater system 100 includes a processor node 101. The processor node 101 includes a processor 102, a processor communication device 103, a storage device 108, and a platform 106. The processor 102 may be any type of processor 102 that is capable of running software and transmitting and receiving latitude data, longitude data, and signal-to-noise ratio data to the nodes 104 via the processor communication device 103 and the storage device 108. Some examples include one or more computers, one or more field programmable gate arrays, one or more graphics processing units, or a combination thereof. In the example shown in FIG. 1, the processor 102 is depicted as a computer. The processor 102 includes software and is operatively connected to a storage device 108 and a processor communication device 103. In an example, the processor 102 may be on a platform 106. The platform 106 may be a stationary platform (e.g., a building, a dock, etc.), a mobile platform (e.g., a ship, an airplane, a drone), or co-located with any node 104 on a node platform 106. Alternatively, in another example, the processor 102 may be not be on any platform 106 and the processor node 101 may be a standalone processor node 101 (e.g., a processor 102 with onboard storage connected to a processor communication device 103 such as a software-defined radio). In the example shown in FIG. 1, the processor node 101 forms an independent node on a platform 106 that includes a processor 102 with software that is operatively connected to a storage device 108 and a processor communication device 103.

The software autonomously and continuously queries latitude data, longitude data, and signal-to-noise ratio data from two or more nodes. In another example, the software also autonomously and continuously queries identification data for each of the two or more nodes. The latitude data, the longitude data, and the signal-to-noise ratio data that is queried is sent to the storage device 108, which timestamps and stores the latitude data, the longitude data, and the signal-to-noise ratio data. In another example, when identification data is queried, the identification data is stored in the storage device 108. The processor 102 can access the stored data in the storage device 108 at any time to perform calculations for the target latitude and the target longitude. The storage device 108 may be co-located with any node 104 as long as the storage device 108 is operatively connected to the processor 102 via the processor node 101. In the example in FIG. 1, the storage device 108 is connected directly to the processor 102 as part of the processor node 101. Any suitable storage device 108 may be used that is capable of storing the latitude data, the longitude data, the signal-to-noise ratio data, and the identification data. The software may be any software capable of running on the processor 102 and querying latitude data, longitude data, and signal-to-noise ratio data and capable of calculating a target latitude and a target longitude for each node. An example of the software includes any radio frequency (RF) propagation modeling software.

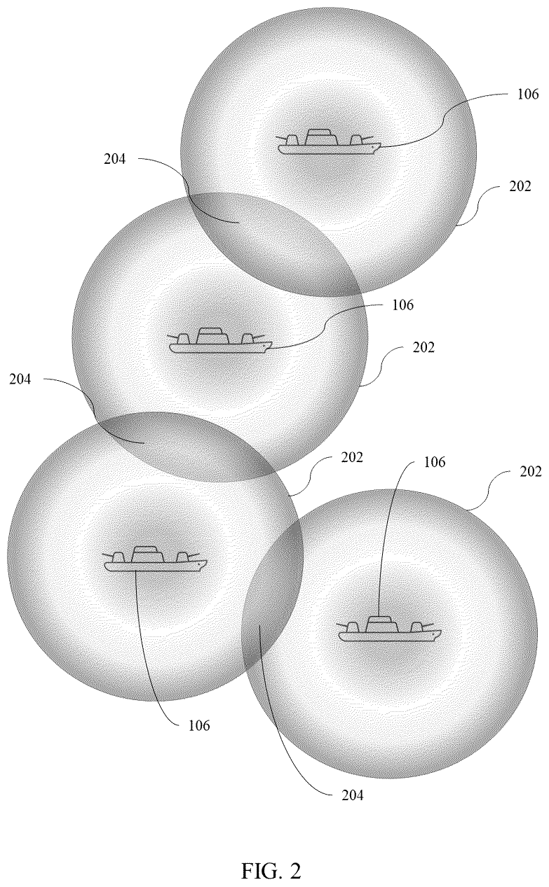

The software also uses the latitude data, longitude data, and signal-to-noise ratio data to calculate a target latitude and a target longitude for each node. In some examples, the software is continuously calculating the target latitude and the target longitude and continuously transmitting the target latitude and the target longitude to each node. In an example, the software calculates the target latitude and the target longitude by determining a coverage plot for each node, calculating maximum signal-to-noise ratio of each overlapped region between the coverage plots using the latitude data, the longitude data, and the signal-to-noise ratio data received from each node. An example of coverage plots 202 for each platform 106 containing a node 104 is shown in FIG. 2. The coverage plots may be determined using any known methods. In an example, coverage plots are typically determined by taking sample points of the signal-to-noise ratio in a radial direction from the node 104 location at specified degree intervals (e.g., 1°, 2°, etc.) and specified distances by interpolating data between each sample point. The software can then review the signal-to-noise ratio of each overlapped region 204 between coverage plots 202 to calculate the optimal target latitude and target longitude for each node 104. The software can calculate the target latitude and target longitude for each node 104 using any known equations. In an example, the software can calculate the target latitude and target longitude for each node 104 using the Free Space Path Loss equation, the Two-Way Ground Reflection equation, the Longley-Rice equation, the Terrain-Integrated Rough-Earth Model (TIREM), or a combination thereof.

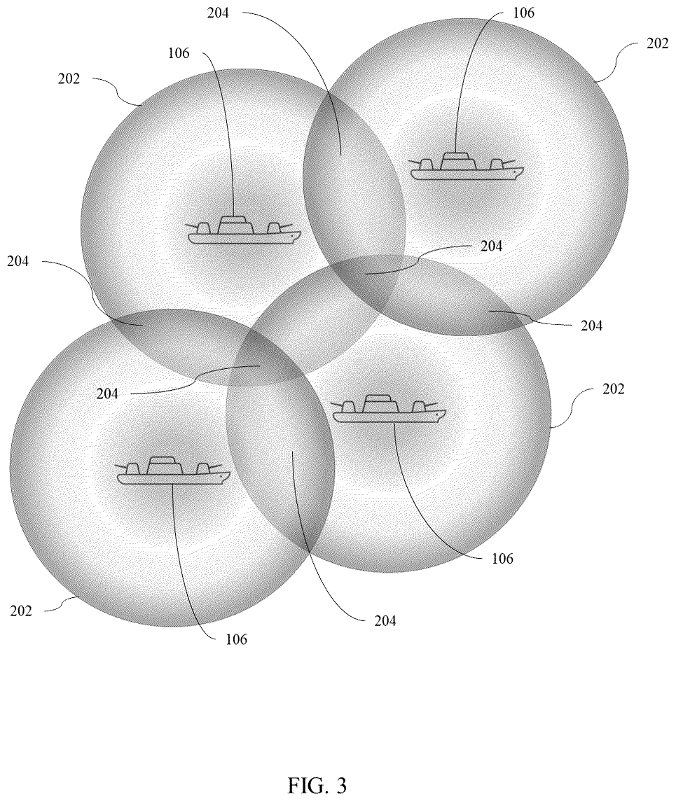

Another example of the coverage plots 202 for each platform 106 containing a node 104 is shown in FIG. 3. In the example in FIG. 3, the software is able to calculate the target latitude and the target longitude in more complex situations where multiple platforms 106 containing a node 104 include an overlapped region 204 using the same equations and methods described for FIG. 2.

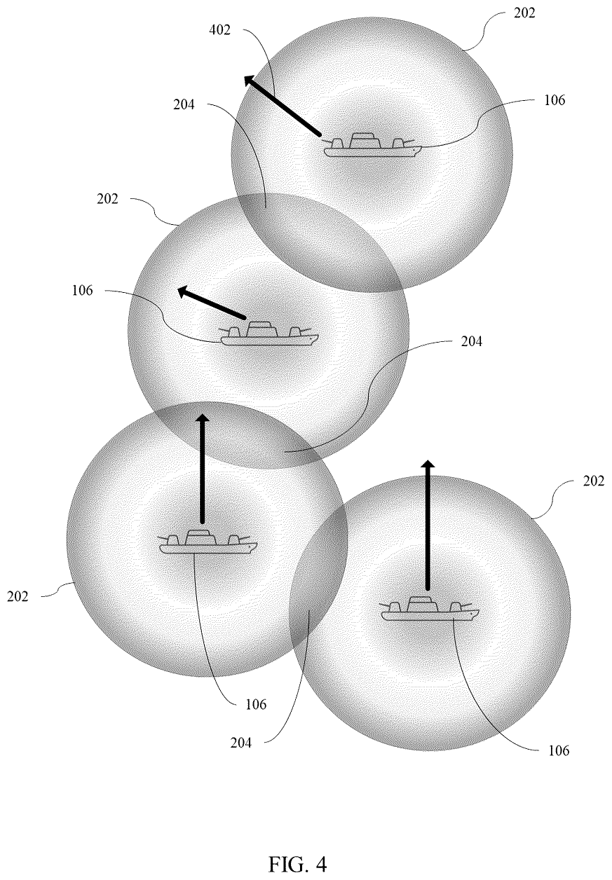

In another example, the software can determine the target latitude and the target longitude of each node 104 using the current time coverage plots 202 and future time coverage plots by projected trajectories of platforms 106 including a node 104. The current and future time coverage plots 202 can be used by the software to calculate the optimal signal-to-noise ratio of each overlapped region 204. An example of using current and future time coverage plots 202 to calculate the target latitude and target longitude of each node 104 is shown in FIG. 4. In FIG. 4, the current time coverage plots 202 are shown with the current overlapping regions 204. The software can determine the future trajectories 402 of each platform 106 with a node 104. The software can then determine what the future coverage plots 202 and future overlapping regions 204 will be using the methods described for FIG. 2. Using the future coverage plots 202 and future overlapping regions 204, the software can determine a future target latitude and target longitude using the equations described for FIG. 2.

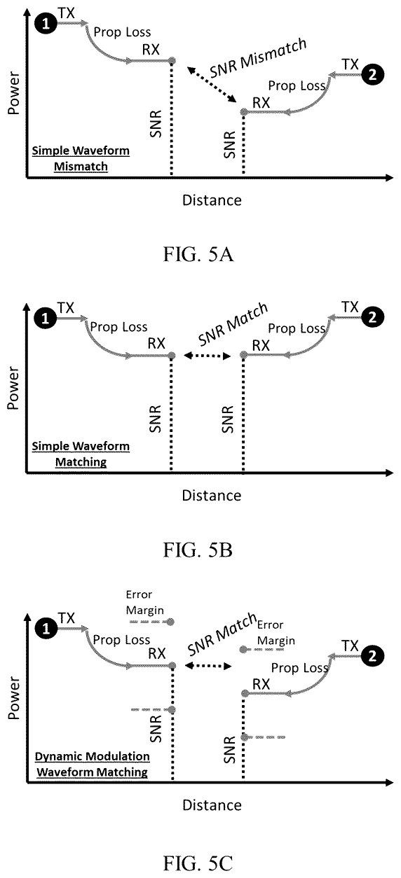

FIG. 5A-5C shows an example of the software using power and distance with respect to an RF transmission and reception signals from a single point on a node coverage plot to another single point on another node coverage plot (labeled 1 and 2 in FIG. 5A-5C) to calculate the signal-to-noise ratio. In FIG. 5A, a signal-to-noise ratio mismatch is shown where the signal-to-noise ratio does not match. As a result, the software can calculate a new target latitude and target longitude to adjust the signal-to-noise ratio to balance the signal-to-noise ratios creating a signal-to-noise ratio match. This is shown in FIG. 5B. In a more dynamic environment or when using dynamic modulation schemas, a preset signal-to-noise ratio margin threshold is set for each node that the software maintains by providing new target latitude and target longitudes when the signal-to-noise ratio is outside the preset signal-to-noise ratio margin threshold. The threshold is shown FIG. 5C using the error margins. When the signal-to-noise ratio between the two nodes (1 and 2) are within the threshold, no changes to the latitude and longitude are needed. Once the signal-to-noise ratio of the nodes is outside the threshold, a new target latitude and target longitude are calculated and the nodes move to the target latitude and target longitude to bring the signal-to-noise ratio back within the threshold.

In other examples, the software can calculate a target latitude and a target longitude can include prioritizing calculating the target latitude and target longitude of one node over other nodes using the method previously described above (i.e., using coverage plots for each node). This can be done the same as previously described herein for FIG. 5A-5C. In another example, the target latitude and the target longitude can be calculated for maximum throughput. Calculations for maximum throughput are particularly useful for dynamically modulated waveforms that can shift to less spectral efficient waveforms. Less spectral efficient waveforms like Binary Phase Shift Keying (BPSK) are more resilient to noise and variation in signal-to-noise ratios. The modulation resiliency allows the throughput to remain the same while signal-to-noise ratios change, within tolerances. Consideration for the modulation resiliency allows for maximum throughput for designated higher priority nodes 104 to be optimized for greater signal-to-noise ratio than lower priority nodes. In an example, node 104 throughput prioritization is particularly useful as the number of nodes exceeds 10 nodes in a mesh network topology.

Referring back to FIG. 1, the processor 102 is operatively connected to a processor communication device 103 that is capable transmitting and receiving the latitude data, longitude data, and signal-to-noise ratio data between the two or more nodes and the processor and transmitting the target latitude and the target longitude calculated for each node. The processor communication device 103 may be any device capable of transmitting and receiving a signal. For example, the processor communication device 103 may be any RF communication device, such as software-defined radio. In another example, the processor communication device 103 may be any acoustic communication device capable of receiving an acoustic communication signal. In the example in FIG. 1, the processor communication device 103 is shown in a sequentially networked coverage scenario. The processor communication device 103 is linked to another node 104 on a node platform 106, which is linked to two other nodes 104 where one node 104 is located on a node platform 106 and one node 104 is a standalone, handheld node 104 with no platform 106.

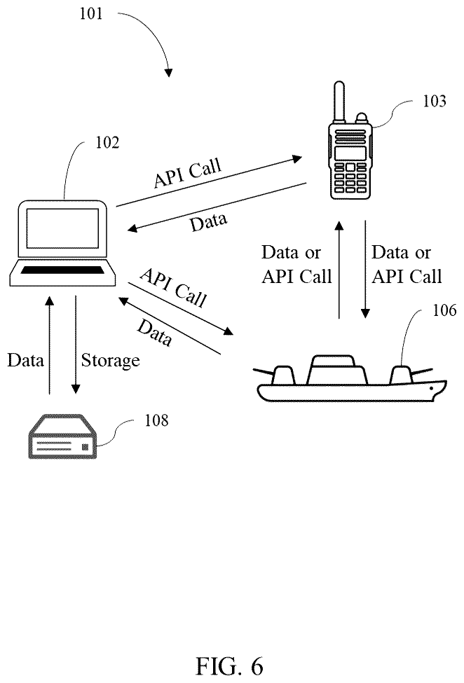

Referring now to FIG. 6, an example of the processor node 101 is shown. In this example, the processor 102 and storage device 108 are co-located on a node platform 106. The node platform 106 includes a processor communication device 103 as a software defined radio that transmits RF signals to other nodes 104 on the network. In this example, the processor communication device 103 of the processor node 101 can use the on board equipment (e.g., an antenna) of the platform 106 to transmit any RF signal to the node network.

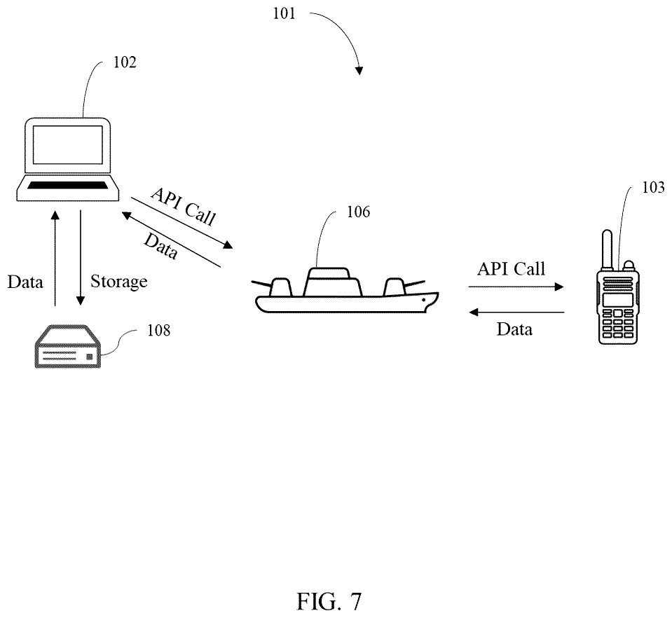

In FIG. 7, another example of the processor node 101 is shown. In this example, the processor 102 uses the onboard networking of the platform 106 as a bus to connect directly to the processor communication devices 103. Similar to FIG. 3, in FIG. 4, the processor communication device 103 is a software-defined radio that transmits RF signals to other nodes 104 on the network. In this example, the processor 102 can also utilize the onboard equipment of the platform 106 for wired intra-node communication and RF inter-node communication across the node network.

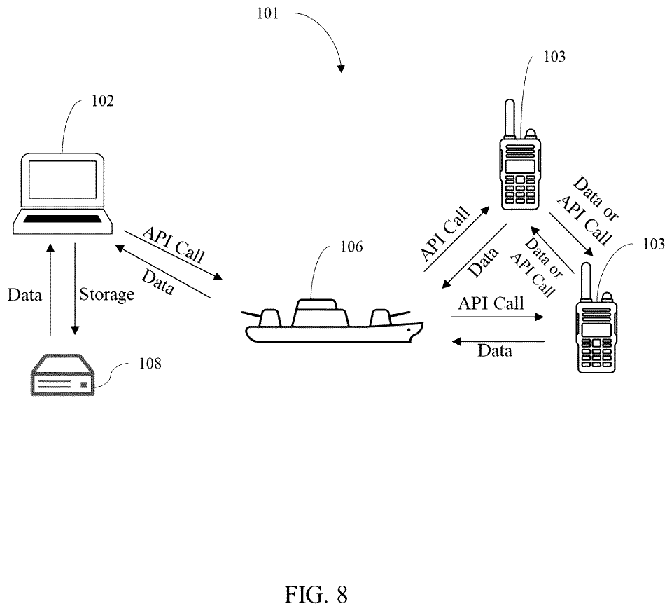

Another example of the processor node 101 is shown in FIG. 8. In this example, the processor 102 uses the onboard networking of the platform 106 as a bus to connect directly to two processor communication devices 103. With two processor communication devices 103, the processor 102 can be connected to multiple node networks or use one of the processor communication devices 103 as a secondary device in the event that the primary processor communication device 103 is not functional. Similarly, in FIG. 8, the two the processor communication devices 103 are software-defined radios that transmits RF signals to other nodes 104 on the network. In this example, the processor 102 can also utilize the onboard equipment of the platform 106 for wired intra-node communication and RF inter-node communication across the node network.

Referring back to FIG. 1, the autonomous repeater system 100 also includes three or more nodes 104. In another example, the autonomous repeater system 100 may include the processor node 101 and two or more nodes 104. Each node 104 includes a node communication device 105 transmits and receives the latitude data, the longitude data, and the signal-to-noise ratio data between the two or more nodes 104 and the processor 102 via the processor communication device 103 and receives the target latitude and the target longitude from the processor communication device 103. There is no limit to the number of nodes 104 in the autonomous repeater system 100 as long as the software can function and calculate target latitudes and target longitudes for each node. In addition, each node 104 may have a separate, independent processor, storage device, or a combination thereof. The storage device 108 may be co-located with any node 104, but still operatively connected to the processor 102. In one example, the nodes 104 may also be a standalone handheld node communication device (e.g., a handheld radio) without a platform 106. In another example, the nodes 104 may be located on or part of an unmanned platform 106, a manned platform 106, or a standalone handheld device 104. In the example in FIG. 1, two nodes 104 are part of a manned or unmanned ship 106 as the platform. The third node 104 in FIG. 1 is a standalone handheld device. Additionally, in the example in FIG. 1, the nodes 104 are connected via a sequentially networked coverage scenario. The two or more nodes 104 may be any device capable of transmitting and receiving a signal. For example, the two or more nodes 104 may be any RF communication device, such as software-defined radio. In another example, the node 104 may be any acoustic communication device capable of receiving an acoustic communication signal.

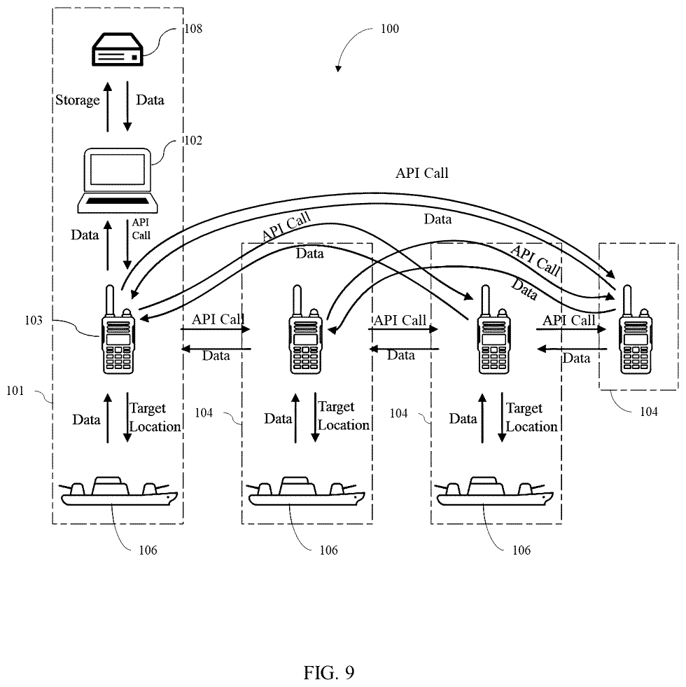

In another example, shown in FIG. 9, the processor node 101 with the processor 102, the processor communication device 103, the storage device 108 and the three nodes 104 are connected via a mesh networked coverage scenario. In FIG. 9, the processor communication device 103 is connected to any node 104 individually to transmit or receive the latitude data, the longitude data, the signal-to-noise ratio data, the target latitude, or the target longitude to any node 104 connected to the mesh network.

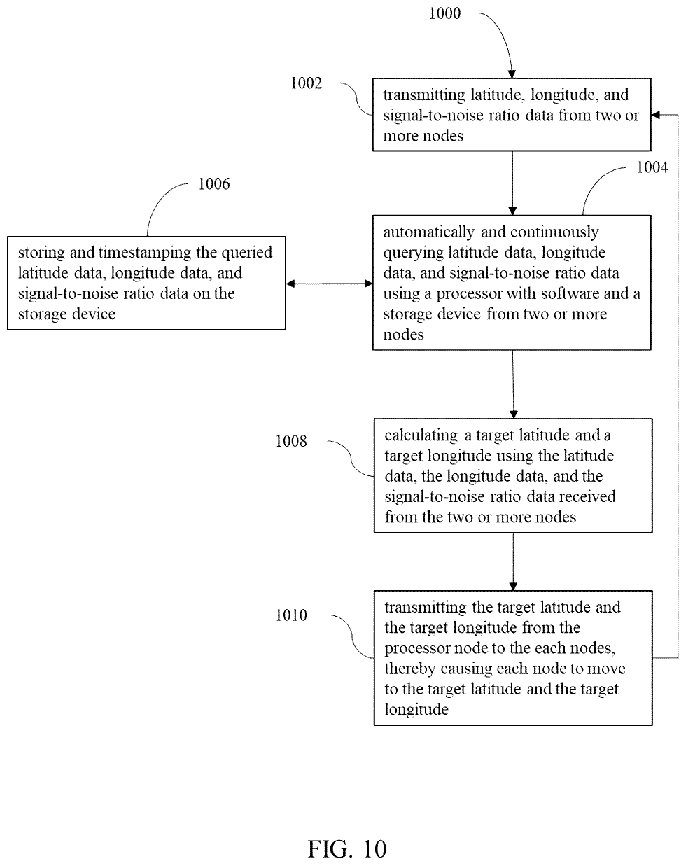

Referring now to FIG. 10, a method 1000 of using an autonomous repeater system. The method 1000 includes a repeating cycle where all the actions of the method can be performed in parallel to each other. Once the two or more nodes are transmitting data, all actions of the method 1000 can be performed simultaneously in parallel. The method 1000 includes transmitting latitude, longitude, and signal-to-noise ratio data from the two or more nodes 1002. In some examples, identification data is also transmitted from the two or more nodes to the processor node. The latitude, longitude, and signal-to-noise ratio data are continuously transmitted from the two or more nodes to the processor node as previously described herein. The processor node is the same processor node as previously described herein. The processor node, functions the same as previously described herein.

Referring back to FIG. 10, the method 1000 includes autonomously and continuously querying latitude data, longitude data, and signal-to-noise ratio data using a processor with software and a storage device from two or more nodes 1004. The processor is on a platform. The platform may be a stationary platform (e.g., a building, a dock, etc.), a mobile platform (e.g., a ship, an airplane, a drone), or co-located with any node on a node platform In some examples, the method 1000 may further include querying identification data for each of the two or more nodes when the identification data is transmitted. The processor and software are the same as previously described herein. The processor and software also function the same as previously described herein.

Referring back to FIG. 10, the method 1000 includes storing and timestamping the queried latitude data, longitude data, and signal-to-noise ratio data on the storage device 1006. In examples where the method 1000 includes querying identification data, the identification data is stored for each of the two or more nodes on the storage device. The storage device is the same and functions the same as previously described herein. The latitude data, the longitude data, and the signal-to-noise ratio data that is queried and stored on the storage device is also timestamped. The processor can access the stored data in the storage device at any time to perform calculations for the target latitude and the target longitude.

Referring back to FIG. 10, the method 1000 includes calculating a target latitude and a target longitude using the latitude data, the longitude data, and the signal-to-noise ratio data received from the two or more nodes 1008. The method 1000 may further include the software continuously calculating the target latitude and the target longitude and continuously transmitting the target latitude and the target longitude for the each node. The target latitude and the target longitude may be calculated or continuously calculated as previously described herein.

Referring back to FIG. 8, the method 1000 includes transmitting the target latitude and the target longitude from the processor node to the each nodes, thereby causing each node to move to the target latitude and the target longitude 1010. The two or more nodes are the same two or more nodes as previously described herein. The nodes may be connected to the processor communication device via a sequentially networked coverage scenario or a mesh networked coverage scenario as previously described herein. The two or more nodes continuously transmit latitude, longitude, and signal-to-noise ratio data are continuously transmitted from the two or more nodes.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of a list should be construed as a de facto equivalent of any other member of the same list merely based on their presentation in a common group without indications to the contrary.

Unless otherwise stated, any feature described herein can be combined with any aspect or any other feature described herein.

Reference throughout the specification to “one example”, “another example”, “an example”, means that a particular element (e.g., feature, structure, and/or characteristic) described in connection with the example is included in at least one example described herein, and may or may not be present in other examples. In addition, the described elements for any example may be combined in any suitable manner in the various examples unless the context clearly dictates otherwise.

The ranges provided herein include the stated range and any value or sub-range within the stated range. For example, a range from about 0.1 to about 20 should be interpreted to include not only the explicitly recited limits of from about 0.1 to about 20, but also to include individual values, such as 3, 7, 13.5, etc., and sub-ranges, such as from about 5 to about 15, etc.

In describing and claiming the examples disclosed herein, the singular forms “a”, “an”, and “the” include plural referents unless the context clearly dictates otherwise.

What is claimed is:

1. Autonomous repeater system, comprising:
a processor node, wherein the processor node includes:
i) a processor, wherein the processor is operatively connected to a storage device and a processor communication device and includes software that operates on the processor;
ii) the software, wherein the software autonomously and continuously queries latitude data, longitude data, and signal-to-noise ratio data from two or more nodes and calculates a target latitude and a target longitude for each node using the latitude data, the longitude data, and the signal-to-noise ratio data received from the two or more nodes; and
iii) the processor communication device, wherein the processor communication device is operatively connected to the processor to transmit and receive the latitude data, longitude data, and signal-to-noise ratio data between the two or more nodes and the processor and transmit the target latitude and the target longitude calculated for each node; and
the storage device, wherein the storage device timestamps and stores the latitude data, the longitude data, and the signal-to-noise ratio data being queried by the software; and
the two or more nodes, wherein each node includes a node communication device that transmits and receives the latitude data, the longitude data, and the signal-to-noise ratio data between the two or more nodes and the processor and receives the target latitude and the target longitude from the processor communication device.

2. The system of claim 1, wherein the processor node further includes a stationary platform, a mobile platform, or is co-located with any node on a node platform.

3. The system of claim 1, wherein the software continuously calculates the target latitude and the target longitude and continuously transmits the target latitude and the target longitude for each node.

4. The system of claim 1, wherein the two or more nodes are software-defined radios that are located on a node platform or a standalone handheld device.

5. The system of claim 1, wherein the software further queries identification data for each of the two or more nodes and the storage device stores the identification data for each of the two or more nodes.

6. The system of claim 1, wherein calculating the target latitude and target longitude includes determining a coverage plot for each node, calculating maximum signal-to-noise ratio of each overlapped region between the coverage plots using the latitude data, the longitude data, and the signal-to-noise ratio data received from each node.

7. The system of claim 6, wherein determining the coverage plot for each node includes current time coverage plots and future time coverage plots using projected node trajectories and calculating the maximum signal-to-noise ratio of each overlapped region includes using the current time coverage plots and future time coverage plots.

8. The system of claim 1, wherein each node is connected via a sequentially networked coverage scenario with the processor communication device.

9. The system of claim 1, wherein each node is connected via a mesh networked coverage scenario where the processor communication device is connected to any node individually to transmit or receive the latitude data, the longitude data, the signal-to-noise ratio data, the target latitude, or the target longitude to any node connected to the mesh network.

10. The system of claim 1, wherein the target latitude and target longitude are determined by prioritizing calculating the target latitude and target longitude of one node over other nodes, calculating the target latitude and the target longitude for maximum coverage, or calculating the target latitude and the target longitude for maximum throughput.

11. A method of using an autonomous repeater system, comprising:
i) transmitting latitude data, longitude data, and signal-to-noise ratio data from two or more nodes;
ii) autonomously and continuously querying the latitude data, the longitude data, and the signal-to-noise ratio data from the two or more nodes using a processor node including a processor, software, a processor communication device, and a storage device;
iii) storing and timestamping the latitude data, the longitude data, and the signal-to-noise ratio data on the storage device;
iv) calculating a target latitude and a target longitude using the latitude data, the longitude data, and the signal-to-noise ratio data received from the two or more nodes; and
v) transmitting the target latitude and the target longitude from the processor node to each nodes, thereby causing each node to move to the target latitude and the target longitude.

12. The method of claim 11, wherein the processor node further includes a stationary platform, a mobile platform, or co-located with any node on a node platform.

13. The method of claim 11, wherein further including repeating i)-v) continuously and autonomously in parallel.

14. The method of claim 11, wherein the two or more nodes are software-defined radios that are located on a node platform or a handheld platform.

15. The method of claim 11, further including querying identification data for each of the two or more nodes and storing the identification data for each of the two or more nodes on the storage device.

16. The method of claim 11, wherein calculating the target latitude and target longitude includes determining a coverage plot for each node, calculating maximum signal-to-noise ratio of each overlapped region between the coverage plots using the latitude data, the longitude data, and the signal-to-noise ratio data received from each node.

17. The method of claim 16, determining the cover plot for each node includes current time coverage plots and future time coverage plots using projected node trajectories and calculating the maximum signal-to-noise ratio of each overlapped region includes using the current time coverage plots and future time coverage plots.

18. The method of claim 11, wherein each node is connected via a sequentially networked coverage scenario with the processor communication device.

19. The method of claim 11, wherein each node is connected via a mesh networked coverage scenario where the processor communication device is connected to any node individually to transmit or receive the latitude data, the longitude data, the signal-to-noise ratio data, the target latitude, or the target longitude to any node connected to the mesh network.

20. The method of claim 11, wherein the target latitude and target longitude are determined by prioritizing calculating the target latitude and target longitude of one node over other nodes, calculating the target latitude and the target longitude for maximum coverage, or calculating the target latitude and the target longitude for maximum throughput.
